(19) United States
(12) Patent Application Publication
(10) Pub. No.: US 2026/0176447 A1
(43) Pub. Date: Jun. 25, 2026

(54) METAL SULFIDE AND USE THEREOF, AND RESIN COMPOSITION CONTAINING THE SAME

(71) Applicant: IKENS INFRARED TECHNOLOGY (GUANGDONG) CO., LTD., GUANGZHOU (CN)

(72) Inventors: JUN LIN, GUANGZHOU (CN); ZEPENG LIN, GUANGZHOU (CN); HUAXIONG LIN, GUANGZHOU (CN)

(21) Appl. No.: 19/538,942

(22) Filed: Feb. 12, 2026

Related U.S. Application Data
(63) Continuation of application No. PCT/CN2024/101574, filed on Jun. 26, 2024.

(51) Int. Cl. C08K 5/098; C08L 67/02

(52) U.S. Cl. CPC C08K 5/098; C08L 67/02; C08L 2666/02

(57) ABSTRACT

The present application discloses a metal sulfide and use thereof, and a resin composition containing the metal sulfide, and relates to the technical field of sulfides. The metal sulfide is a zinc sulfide material containing a cobalt element and an iron element, the cobalt element has a mass content of 200-500 ppm in the zinc sulfide material, and the iron element has a mass content of 3-200 ppm in the zinc sulfide material; a mass content of zinc in the zinc sulfide material and a pH value of the zinc sulfide material satisfy the following relationship: 1.2≤pH−2.5×lg(W_{Zn})≤3.3; where the pH is the pH value of the zinc sulfide material, and W_{Zn} is the mass content of zinc in the zinc sulfide material, expressed in %.

### TECHNICAL FIELD

The present application relates to the technical field of sulfides, and specifically, to a metal sulfide and use thereof, and a resin composition containing the metal sulfide.

### BACKGROUND

With the widespread application of plastic products in fields such as household appliances, power tools, and outdoor equipment, higher requirements are placed on the appearance of plastics. In general, a certain amount of pigment can be added to plastics to achieve a specific appearance, such as producing white or light-colored plastic products by adding a white pigment. Zinc sulfide (ZnS), as a white pigment, has a high refractive index and opacity, is easily dispersed and not prone to agglomeration, and, when applied in plastics, can provide materials with good hiding power and whitening effect.

However, for white plastic products used in water environments, such as toys in water parks or accessories in aquariums, long-term contact between the plastic and water after prolonged soaking may cause color changes in the plastic products. Such color changes can result from dissolution, bleaching, or diffusion of the white pigment, or reactions between the white pigment and chemical substances in water, thereby affecting the appearance of the plastic products. In addition, elevated water temperatures can accelerate the color changes of the plastic products.

Therefore, there is a need to provide a zinc sulfide material with minimal whiteness variation after water treatment for application in plastic products with high requirements for color stability.

### SUMMARY

To overcome the deficiencies in the prior art, an objective of the present application is to provide a metal sulfide and use thereof, and a resin composition containing the metal sulfide. By controlling the contents of cobalt and iron elements and reasonably defining the zinc content and pH value of the metal sulfide, the resin composition containing the metal sulfide exhibits high color stability and a low whiteness variation rate after prolonged water treatment.

To achieve the foregoing objective, according to a first aspect, the present application provides a metal sulfide, where the metal sulfide is a zinc sulfide material containing a cobalt element and an iron element, the cobalt element has a mass content of 200-500 ppm in the zinc sulfide material, and the iron element has a mass content of 3-200 ppm in the zinc sulfide material; and
a mass content of zinc in the zinc sulfide material and a pH value of the zinc sulfide material satisfy the following relationship:

$$1. 2 \leq pH - 2.5 \times lg ( {W}_{Zn} ) \leq 3.3 ;$$

where the pH is the pH value of the zinc sulfide material, and W_{Zn} is the mass content of zinc in the zinc sulfide material, expressed in %.

In a preferred embodiment of the present application, the cobalt element has a mass content of 250-400 ppm in the zinc sulfide material.

In a preferred embodiment of the present application, the iron element has a mass content of 6-150 ppm in the zinc sulfide material.

In a preferred embodiment of the present application, the mass content of zinc in the zinc sulfide material and the pH value of the zinc sulfide material satisfy the following relationship: 1.5≤pH−2.5×lg(W_{Zn})≤3.0.

In a preferred embodiment of the present application, the mass content of zinc in the zinc sulfide material is 62.0-67.1%, preferably 63.5-67.0%.

In a preferred embodiment of the present application, the pH value of the zinc sulfide material is 5.5-8.0, preferably 6.1-7.5.

In a preferred embodiment of the present application, the zinc sulfide material further includes a chromium element, and a mass content of the chromium element in the zinc sulfide material is 10-25.2 ppm.

In a preferred embodiment of the present application, the zinc sulfide material has a heating loss of ≤0.5% at 105° C.

According to a second aspect, the present application provides use of the metal sulfide in preparation of a resin composition.

According to a third aspect, the present application provides a resin composition, which includes the following components in parts by weight:

100 parts of resin, and 0.5-10 parts of the metal sulfide.

In a preferred embodiment of the present application, the resin includes at least one of polyethylene (PE), polypropylene (PP), polyamide (PA), polycarbonate (PC), poly(butylene terephthalate) (PBT), poly(ethylene terephthalate) (PET), epoxy resin (EP), acrylonitrile-butadiene-styrene (ABS) copolymer, or styrene-acrylonitrile (AS) copolymer.

The present application has the following beneficial effects.

The metal sulfide of the present application has appropriate cobalt and iron contents, and the zinc content and pH value of the metal sulfide are reasonably controlled, such that the resin composition containing the metal sulfide exhibits high color stability and a low whiteness variation rate after prolonged water treatment.

### DETAILED DESCRIPTION OF THE EMBODIMENTS

To make the objectives, technical solutions, and beneficial effects of the embodiments of the present application clearer, the technical solutions in the embodiments of the present application are described below in a clear and complete manner. It is apparent that the described embodiments are some but not all of embodiments of the present application. All other embodiments obtained by those of ordinary skill in the art based on embodiments of the present application without creative efforts shall fall within the protection scope of the present application.

In the present application, for the technical features described in an open-ended manner, both closed technical solutions composed of the listed features and open-ended technical solutions including the listed features are encompassed.

In the present application, with respect to numerical ranges, unless otherwise specified, the ranges are considered continuous and include both the minimum and maximum values of the range, as well as every value between the minimum and maximum. Further, when the ranges refer to integers, every integer between the minimum and maximum values of the range is included. In addition, when a plurality of range-describing features or properties are provided, the ranges can be combined. In other words, unless otherwise indicated, all ranges disclosed herein are to be understood as including any and all sub-ranges encompassed therein.

In the present application, the dispersion or stirring treatment methods are not particularly limited.

The reagents or instruments used in the present application, for which the manufacturer is not specified, are conventional products that can be obtained commercially.

An embodiment of the present application provides a metal sulfide, where the metal sulfide is a zinc sulfide material containing a cobalt element and an iron element, the cobalt element has a mass content of 200-500 ppm in the zinc sulfide material, and the iron element has a mass content of 3-200 ppm in the zinc sulfide material; and
a mass content of zinc in the zinc sulfide material and a pH value of the zinc sulfide material satisfy the following relationship:

$$1. 2 \leq pH - 2.5 \times lg ( {W}_{Zn} ) \leq 3.3 ;$$

where the pH is the pH value of the zinc sulfide material, and W_{Zn} is the mass content of zinc in the zinc sulfide material, expressed in %.

For zinc sulfide materials, it is generally difficult to achieve 100% purity of zinc sulfide, which contains a certain amount of impurity elements, such as cobalt and iron. Studies of the present application have found that both cobalt and iron affect the color and stability of the zinc sulfide material. Pure zinc sulfide is generally white or pale yellow, whereas zinc sulfide materials containing a certain amount of cobalt typically exhibit a pale blue or light green hue, and zinc sulfide materials containing a certain amount of iron typically exhibit a yellowish or brownish hue. When the content of iron or cobalt is excessive, a relatively large amount of iron ions and cobalt ions may cause oxidation or decomposition reactions, which decrease the stability of the resin composition containing the zinc sulfide material, thereby resulting in color change.

Therefore, when a zinc sulfide material containing a relatively high mass content of cobalt element or iron element is added to a resin, the obtained resin composition, when applied in a water environment, tends to exhibit a relatively large whiteness variation.

However, studies of the present application have found that lower mass contents of cobalt element and iron element are not necessarily preferable. Appropriate mass contents of cobalt element and iron element contribute to improved stability of the zinc sulfide material and result in a lower color variation rate of the resin composition containing the zinc sulfide material. When a resin composition containing a zinc sulfide material is applied in a water environment, cobalt element and iron element are prone to ionization to form cobalt ions and iron ions. Such ions may substitute for zinc ions or sulfur ions in a zinc sulfide crystal lattice, thereby introducing additional lattice defects, including vacancies or substitutional ions. In addition, when cobalt ions and iron ions are ionized and incorporated into the zinc sulfide crystal lattice, surrounding zinc sulfide ions may undergo displacement to accommodate the size and charge of the cobalt ions and iron ions. This displacement may lead to lattice relaxation, which results in changes to the parameters of the zinc sulfide lattice, such as the lattice constant. Appropriate distortion and defects formed in zinc sulfide crystals may hinder crystal growth and grain boundary diffusion, restrict crystal size and morphology, and promote a more uniform and compact structure, thereby reducing internal voids and cracks within the crystals. In addition, such defects may alter the band structure of zinc sulfide, adjust electronic energy levels and band gaps, and thereby influence chemical reactivity, resulting in improved stability of the zinc sulfide material and consequently affecting the stability of the resin composition containing the zinc sulfide material.

In the present application, by controlling the mass content of cobalt element in the zinc sulfide material to be 200-500 ppm and controlling the mass content of iron element to be 3-200 ppm, the stability of the zinc sulfide material is enhanced without adversely affecting the inherent color of the zinc sulfide material, and the color variation rate of the resin composition containing the zinc sulfide material is reduced.

Studies of the present application have found that the pH of the zinc sulfide material not only affects the acidity and alkalinity of the resin composition containing the zinc sulfide material, but also affects the color stability of the resin composition in a water environment. After the zinc sulfide material is added to the resin, changes in the pH value of the resin system may cause changes in the interaction between the zinc sulfide material and the resin. An appropriate pH value enhances the interfacial bonding strength between the zinc sulfide material and the resin without causing deterioration of the properties of the resin itself, thereby facilitating improved color stability of the resin composition containing the zinc sulfide material. When the pH is excessively high or excessively low, deterioration of the properties of the resin composition, a decrease in stability, or occurrence of other chemical reactions may be caused, thereby resulting in excessive color variation of the material.

In addition, the pH of the zinc sulfide material is correlated with the zinc content. When the mass content of zinc in the zinc sulfide material is high, the concentration of zinc ions in the aqueous solution is also high, which in turn increases the acidity of the solution and lowers the pH value. Therefore, the zinc content in the zinc sulfide material needs to be controlled in coordination with the pH value. Studies of the present application have found that when the pH value and zinc content satisfy the relationship: 1.2≤pH−2.5×lg(W_{Zn})≤3.3, both the pH value and the zinc content of the zinc sulfide material are within an optimal range, and the color stability of the resin composition containing the zinc sulfide material is relatively higher.

It should be noted that the pH of the zinc sulfide material is influenced by various factors, such as the synthesis method and post-treatment process of the zinc sulfide, which indicates that the pH of the zinc sulfide is not linearly related to the zinc content.

In the present application, the mass content of iron element, the mass content of cobalt element, and the mass content of zinc in the zinc sulfide material may be measured by atomic absorption spectroscopy (AAS).

In the present application, the pH of the zinc sulfide material may be measured as follows: the zinc sulfide material is dispersed in water to form a suspension sample under ultrasonic stirring; a calibrated pH electrode is immersed in the suspension sample to ensure sufficient contact between the electrode and the sample; and the reading is recorded after the measurement stabilizes.

In the present application, the value of pH−2.5×lg(W_{Zn}) may be 1.2, 1.3, 1.5, 1.8, 2.0, 2.5, 3.0, or 3.3, or may be a range formed by any two of the above values.

In the present application, the mass content of the cobalt element in the zinc sulfide material may be 200 ppm, 210 ppm, 220 ppm, 250 ppm, 300 ppm, 400 ppm, or 500 ppm, or may be a range formed by any two of the above values.

In the present application, the mass content of the iron element in the zinc sulfide material may be 3 ppm, 10 ppm, 20 ppm, 50 ppm, 100 ppm, 150 ppm, or 200 ppm, or may be a range formed by any two of the above values.

In an embodiment, the cobalt element has a mass content of 250-400 ppm in the zinc sulfide material.

In an embodiment, the iron element has a mass content of 6-150 ppm in the zinc sulfide material.

In the above preferred mass content of the cobalt and/or iron elements, the stability of the zinc sulfide material is relatively improved, and the whiteness variation rate of the resin composition containing the zinc sulfide material is relatively lower.

In an embodiment, the mass content of zinc in the zinc sulfide material and the pH value of the zinc sulfide material satisfy the following relationship: 1.5≤pH−2.5×lg(W_{Zn})≤3.0.

When the relationship is within the above preferred range, the mass content of zinc and the pH value in the zinc sulfide material are relatively balanced, resulting in better stability of the zinc sulfide material.

In an embodiment, the mass content of zinc in the zinc sulfide material is 62.0-67.1%, and may be, for example, 62.0%, 62.5%, 63.0%, 64.0%, 65.0%, or 67.1%, or a range formed by any two of the above values.

In a preferred embodiment, the mass content of zinc in the zinc sulfide material is 63.5-67.0%.

The zinc content in the zinc sulfide material is related to the purity of the zinc sulfide. The higher the purity, the higher the zinc content. As the purity of the zinc sulfide decreases, the zinc content decreases accordingly. Generally, when the zinc content is higher, the zinc sulfide material exhibits a lighter color, resulting in better performance when used as a white pigment. However, a higher zinc content indicates that the purity of the zinc sulfide is higher, which may correspondingly reduce the relative mass content of the cobalt element and the iron element; in addition, a higher zinc content may cause the pH value to decrease correspondingly, thereby affecting the color stability of the resin composition containing the zinc sulfide material.

In an embodiment, the pH of the zinc sulfide material is 5.5-8.0, and may be, for example, 5.5, 5.8, 6.0, 6.5, 7.0, 7.5, or 8.0, or a range formed by any two of the above values.

In a preferred embodiment, the pH of the zinc sulfide material is 6.1-7.5.

When the pH of the zinc sulfide material is within a near-neutral to slightly acidic range, the material tends to maintain higher stability and, after being incorporated into a resin, does not significantly adversely affect the intrinsic properties of the resin.

In an embodiment, the zinc sulfide material further includes a chromium element, where the mass content of the chromium element in the zinc sulfide material is 10-25.2 ppm, and may be, for example, 10 ppm, 15 ppm, 18 ppm, 20 ppm, or 25.2 ppm, or a range formed by any two of the above values.

The presence of the chromium element in the zinc sulfide material can improve the heat resistance and oxidation resistance of the zinc sulfide. The chromium element can react with oxygen to form chromium oxide (Cr₂O₃) adhering to the surface of the zinc sulfide particles. Chromium oxide exhibits high thermal stability and oxidation resistance, which can reduce decomposition or oxidation of the zinc sulfide and improve the stability of the zinc sulfide. In addition, the chromium element can occupy part of the vacancies in the zinc sulfide lattice to stabilize the lattice structure, thereby enhancing the heat resistance of the zinc sulfide material. However, when the content of the chromium element is relatively high, the zinc sulfide may exhibit a light green or pale purple color, which can affect the color of the resin compositions containing the zinc sulfide material.

In the present application, the mass content of the chromium element in the zinc sulfide material may be measured by atomic absorption spectroscopy (AAS).

In the present application, the mass contents of the cobalt element, iron element, chromium element, and the zinc content in the zinc sulfide material can be adjusted by selecting suitable zinc sulfide raw ore. Alternatively, the contents can be adjusted by a synthetic method, in which a suitable zinc compound and sulfur source are used to synthesize zinc sulfide, and a certain amount of cobalt element, iron element, and chromium element are added via a deposition method. In addition, the cobalt element, iron element, and chromium element in the zinc sulfide material may also originate from the equipment used in the preparation process of the zinc sulfide material.

In an embodiment, the zinc sulfide material has a heating loss of ≤0.5% at 105° C., and may be, for example, 0.5%, 0.4%, 0.3%, 0.2%, 0.15%, or 0.1%, or a range formed by any two of the above values.

The heating loss of the zinc sulfide material can be measured by conventional methods known in the art. For example, an appropriate amount of a zinc sulfide material sample is accurately weighed, and the mass is recorded as m1. The sample is placed in a heating apparatus, with the temperature set to 105° C. and the relative humidity controlled below 10% RH, and heated until the sample reaches constant weight. After cooling to room temperature, the sample is accurately weighed again, and the mass is recorded as m2. The heating loss at 105° C. is then calculated as: Heating loss at 105° C.=(m1−m2)/m1*100%.

The heating loss of the zinc sulfide material at 105° C. mainly reflects the moisture content in the zinc sulfide material. A low moisture content in the zinc sulfide material can slow down the decomposition rate of the zinc sulfide material, thereby improving the stability of the zinc sulfide material. In addition, the zinc sulfide material with a low moisture content can be more tightly bonded to the resin after being added to the resin, so that the zinc sulfide material is not easily separated from the resin, resulting in discoloration of the resin composition.

In the present application, the heating loss of the zinc sulfide material at 105° C. can be adjusted by performing appropriate drying treatment on the zinc sulfide material.

An embodiment of the present application provides use of the metal sulfide in preparation of a resin composition.

An embodiment of the present application provides a resin composition, which includes the following components in parts by weight:

100 parts of resin, and 0.5-10 parts of the metal sulfide.

In an embodiment, the resin includes at least one of polyethylene (PE), polypropylene (PP), polyamide (PA), polycarbonate (PC), poly(butylene terephthalate) (PBT), poly(ethylene terephthalate) (PET), epoxy resin (EP), acrylonitrile-butadiene-styrene (ABS) copolymer, or styrene-acrylonitrile (AS) copolymer.

In practical applications, based on actual performance requirements, the resin composition may further include 0-10 parts by weight of other additives. The other additives are selected from at least one of lubricants, yellowing inhibitors, antioxidants, heat stabilizers, light stabilizers, other polymers, impact modifiers, flame retardants, optical brighteners, plasticizers, thickeners, antistatic agents, release agents, or nucleating agents.

It should be noted that the preparation method of the resin composition is not particularly limited in the present application. Those skilled in the art can prepare the resin composition using conventional techniques.

For example, the preparation method of the resin composition includes the following steps:

mixing the resin, the metal sulfide, and other additives, adding the mixture to an extruder, and performing melt mixing and extrusion to produce the resin composition.

Specifically, the extruder can be a twin-screw extruder, where the length-diameter ratio of screws of the twin-screw extruder is 36-72:1, the rotating speed of the screws is 100-500 rpm, and the melting temperature of the twin-screw extruder is 180-280° C.

After a 25° C. water treatment test, the whiteness variation rate of the resin composition is ≤8%. The specific conditions of the 25° C. water treatment test are as follows: the resin composition is injection-molded into a specimen with a thickness of 2 cm; and the specimen was immersed in a 25° C. water bath for 12 h, removed and dried, allowed to stand at room temperature for 12 h, and then immersed again in the 25° C. water bath to constitute one cycle; a total of 50 cycles are performed.

After a 50° C. water treatment test, the whiteness variation rate of the resin composition is ≤15%. The specific conditions of the 50° C. water treatment test are as follows: the resin composition is injection-molded into a specimen with a thickness of 2 cm; and the specimen was immersed in a 50° C. water bath for 12 h, removed and dried, allowed to stand at room temperature for 12 h, and then immersed again in the 50° C. water bath to constitute one cycle; a total of 50 cycles are performed.

The present application is further illustrated by the following specific examples: Examples and Comparative Examples

Examples and comparative examples of the present application each prepare a zinc sulfide material. The preparation of the zinc sulfide material includes the following steps:
S1. dissolving zinc sulfate and sodium sulfide in water, and reacting at 50-80° C. under stirring, with the pH of the reaction system controlled at 4-7 using sulfuric acid;
S2. after completion of the reaction, cooling, separating, and obtaining a product;
S3. adding the obtained product to dilute hydrochloric acid for acidification to obtain an acidified product; and
S4. washing the acidified product three times with deionized water, and drying to obtain the zinc sulfide material.

The cobalt content, iron content, chromium content, and zinc content in the zinc sulfide material are adjusted by selecting zinc sulfate and sodium sulfide with specific cobalt, iron, and chromium contents and controlling the molar ratio of zinc sulfate to sodium sulfide; the pH value of the zinc sulfide material is adjusted by controlling the temperature and time of the acidification treatment; and the heating loss of the zinc sulfide material at 105° C. is adjusted by controlling the drying adjustment.

The mass content of cobalt element, iron element, chromium element, and zinc in the prepared zinc sulfide material is measured using atomic absorption spectroscopy, and the cobalt content (ppm), iron content (ppm), chromium content (ppm), and zinc content W_{Zn} (%) are obtained as shown in Table 1.

The heating loss of the zinc sulfide material at 105° C. is measured using the following method: an appropriate amount of a zinc sulfide material sample is accurately weighed, and the mass is recorded as m1; the sample is placed in a heating apparatus, with the temperature set to 105° C. and the relative humidity controlled below 10% ORH, and heated until the sample reaches constant weight; after cooling to room temperature, the sample is accurately weighed again, and the mass is recorded as m2; the heating loss at 105° C. is then calculated as: Heating loss at 105° C.=(m1−m2)/m1*100%, and the heating loss at 105° C. is obtained as shown in Table 1.

The pH value of the zinc sulfide material is measured using the following method: the zinc sulfide material is dispersed in water to form a suspension sample under ultrasonic stirring; a calibrated pH electrode is immersed in the suspension to ensure sufficient contact between the electrode and the sample, the reading is recorded after the measurement stabilizes, and the pH value is obtained as shown in Table 1.

Specifically, the measured parameter values of the zinc sulfide materials of Examples 1-10 and Comparative Examples 1-5 are shown in Table 1.

TABLE 1
Measured parameter values of zinc sulfide materials

| | | | | Heating | Zinc | | |
|---|---|---|---|---|---|---|---|
| | Cobalt | Iron | Chromium | loss at | content | | |
| | content | content | content | 105° C. | W_{Zn} | pH | pH − 2.5 × |
| | (ppm) | (ppm) | (ppm) | (%) | (%) | value | lg(W_{Zn}) |
| Example 1 | 303.6 | 61.1 | 21.7 | 0.19 | 65.58 | 6.14 | 1.60 |
| Example 2 | 313.7 | 6.3 | 12.7 | 0.22 | 63.64 | 7.5 | 2.99 |
| Example 3 | 376.1 | 115.9 | 25.2 | 0.21 | 67 | 6.9 | 2.33 |
| Example 4 | 398.1 | 137 | 15.6 | 0.34 | 63.8 | 7.3 | 2.79 |
| Example 5 | 266.5 | 24.7 | 4.7 | 0.12 | 64.74 | 6.34 | 1.81 |
| Example 6 | 375.3 | 122.4 | 14.6 | 0.53 | 62.7 | 6.2 | 1.71 |
| Example 7 | 436.7 | 170.5 | 24.6 | 0.18 | 66.5 | 6.9 | 2.34 |
| Example 8 | 227.4 | 3.7 | 17.9 | 0.19 | 64.3 | 6.6 | 2.08 |
| Example 9 | 386.9 | 131.6 | 15.1 | 0.24 | 65 | 7.8 | 3.27 |
| Example 10 | 390.8 | 135.2 | 15.3 | 0.24 | 67.1 | 5.8 | 1.23 |
| Comparative | 143.2 | 126.4 | 10.5 | 0.22 | 65.4 | 6.3 | 1.76 |
| Example 1 | | | | | | | |
| Comparative | 296.5 | 1.3 | 16.4 | 0.19 | 64.5 | 7.2 | 2.68 |
| Example 2 | | | | | | | |
| Comparative | 608.1 | 244.9 | 23.4 | 0.23 | 65.1 | 6.4 | 1.87 |
| Example 3 | | | | | | | |
| Comparative | 381.1 | 177.6 | 16.9 | 0.28 | 62.1 | 8 | 3.52 |
| Example 4 | | | | | | | |
| Comparative | 264.3 | 110.9 | 13.2 | 0.25 | 66.2 | 5.5 | 0.95 |
| Example 5 | | | | | | | |

The zine sulfide materials prepare in each of examples an comparative examples were used as white pigments. A resin composition was prepared according to the following component amounts (parts by weight): 100 parts of polyethylene resin, 3 parts of white pigment, and 1 part of antioxidant 1010.

The resin composition was prepared according to the following steps:

the polyethylene resin, white pigment (zinc sulfide material), and antioxidant 1010 were mixed and fed into a twin-screw extruder; the screw rotation speed of the twin-screw extruder was set at 300 rpm, and the melt temperature was set at 260° C.; and after melt mixing and extrusion, the resin composition was obtained.

The color stability of the resin composition was tested, and the results are shown in Table 2. The specific testing method was as follows:

The room-temperature whiteness variation was measured as follows: the resin composition was injection molded into a specimen with a thickness of 2 cm, and the whiteness value (W1) was measured; the resin composition was then subjected to a 25° C. water treatment test, where the specific conditions of the 25° C. water treatment test were as follows: the specimen was immersed in a 25° C. water bath for 12 h, removed and dried, placed at room temperature for 12 h, and then reimmersed in the 25° C. water bath to constitute one cycle; a total of 50 cycles were performed; after the 25° C. water treatment test, the whiteness value (W2) was measured again, and the room-temperature whiteness variation rate (ΔWa) was calculated as ΔWa=(W1−W2)/W1*100%.

The high-temperature whiteness variation was measured as follows: the resin composition was injection molded into a specimen with a thickness of 2 cm, and the whiteness value (W3) was measured; the resin composition was then subjected to a 50° C. water treatment test, where the specific conditions of the 50° C. water treatment test were as follows: the specimen was immersed in a 50° C. water bath for 12 h, removed and dried, placed at room temperature for 12 h, and then reimmersed in the 50° C. water bath to constitute one cycle; a total of 50 cycles were performed; after the 50° C. water treatment test, the whiteness value (W4) was measured again, and the high-temperature whiteness variation rate (ΔWb) was calculated as ΔWb=(W3-W4)/W3*100%.

The whiteness value was measured as follows:

the chromaticity of the specimen was determined using a spectrophotometer SD5000 (Nippon Denshoku Industries Co., Ltd., Japan), and the brightness (L), red value (a), and yellow value (b) were calculated according to the Hunter color difference formula. The whiteness (W) was then calculated according to the following equation: W=100−[(100−L)²+a²+b²]^{1/2}.

TABLE 2
Color stability of resin compositions

| | Room-temperature | High-temperature |
|---|---|---|
| | whiteness | whiteness |
| | variation rate | variation rate |
| | ΔWa | ΔWb |
| Example 1 | 3.6% | 9.9% |
| Example 2 | 4.2% | 10.5% |
| Example 3 | 3.1% | 8.7% |
| Example 4 | 3.3% | 8.9% |
| Example 5 | 5.8% | 14.1% |
| Example 6 | 6.2% | 12.5% |
| Example 7 | 5.5% | 12.7% |
| Example 8 | 5.6% | 12.9% |
| Example 9 | 7.2% | 14.7% |
| Example 10 | 6.9% | 14.3% |
| Comparative Example 1 | 10.6% | 20.5% |
| Comparative Example 2 | 11.5% | 20.9% |
| Comparative Example 3 | 13.2% | 22.6% |
| Comparative Example 4 | 12.7% | 21.2% |
| Comparative Example 5 | 11.9% | 21.7% |

As shown in Table 2, the zinc sulfide materials of the various examples of the present application effectively improved the color stability of the resin compositions. After the 25° C. water treatment test, the whiteness variation rate of the resin compositions was ≤8%, and after the 50° C. water treatment test, the whiteness variation rate of the resin compositions was 15%.

It can be seen from the test results of Example 5 and Examples 1-4, when the chromium content in the zinc sulfide material is relatively low, the color stability of the resin composition is poor, particularly with a higher whiteness variation rate at high temperature. It can be seen from the test results of Examples 6-8 that the mass content of cobalt element in the zinc sulfide material is preferably 250-400 ppm, the mass content of iron element is preferably 6-150 ppm, and the heating loss of the zinc sulfide material at 105° C. is preferably not greater than 0.5%.

It can be seen from the test results of Examples 9-10 and Examples 1-4 that when the contents of the elements are within suitable ranges and the value of pH−2.5×lg(W_{Zn}) further satisfies 1.5-3.0, the resin composition exhibits a smaller whiteness variation under room-temperature or high-temperature water treatment conditions.

It can be seen from the test results of Comparative Examples 1-5 that when the cobalt element or iron element in the zinc sulfide material exceeds the ranges defined in the present application, or when the value of pH−2.5×lg(W_{Zn}) is too high or too low, the resulting resin composition exhibits a large color variation.

It should be noted that although only the polyethylene resin is used as the resin component of the resin composition in the examples of the present application, practically, comparable color stability effects can be achieved when the polyethylene resin is replaced with other thermoplastic or thermosetting resins, such as polyethylene, polyamide, polycarbonate, poly(butylene terephthalate), poly(ethylene terephthalate), epoxy resin, acrylonitrile-butadiene-styrene copolymer, or styrene-acrylonitrile copolymer.

Finally, it should be noted that the above examples are provided merely to illustrate the technical solutions of the present application and do not limit the scope of protection of the present application. Although the present application has been described in detail with reference to the preferred examples, those of ordinary skill in the art should understand that modifications or equivalent substitutions can be made to the technical solutions of the present application without departing from the spirit and scope of the present application.

What is claimed is:

1. A metal sulfide, wherein the metal sulfide is a zinc sulfide material containing a cobalt element and an iron element, the cobalt element has a mass content of 200-500 ppm in the zinc sulfide material, and the iron element has a mass content of 3-200 ppm in the zinc sulfide material;
a mass content of zinc in the zinc sulfide material and a pH value of the zinc sulfide material satisfy the following relationship:
$$1. 2 \leq pH - 2.5 \times lg ( {W}_{Zn} ) \leq 3.3 ;$$
where the pH is the pH value of the zinc sulfide material, and W_{Zn} is the mass content of zinc in the zinc sulfide material, expressed in %.

2. The metal sulfide according to claim 1, wherein the cobalt element has a mass content of 250-400 ppm in the zinc sulfide material.

3. The metal sulfide according to claim 1, wherein the iron element has a mass content of 6-150 ppm in the zinc sulfide material.

4. The metal sulfide according to claim 1, wherein the mass content of zinc in the zinc sulfide material and the pH value of the zinc sulfide material satisfy the following relationship:
$$1.5 \leq pH - 2.5 \times lg ( {W}_{Zn} ) \leq 3. .$$

5. The metal sulfide according to claim 1, wherein the mass content of zinc in the zinc sulfide material is 62.0-67.1%.

6. The metal sulfide according to claim 1, wherein the pH value of the zinc sulfide material is 5.5-8.0.

7. The metal sulfide according to claim 1, wherein the zinc sulfide material further comprises a chromium element, and a mass content of the chromium element in the zinc sulfide material is 10-25.2 ppm.

8. The metal sulfide according to claim 1, wherein the zinc sulfide material has a heating loss of ≤0.5% at 105° C.

9. Use of the metal sulfide according to claim 1 in preparation of a resin composition.

10. A resin composition, comprising the following components in parts by weight:
100 parts of resin, and 0.5-10 parts of metal sulfide;
wherein the metal sulfide is a zinc sulfide material containing a cobalt element and an iron element, the cobalt element has a mass content of 200-500 ppm in the zinc sulfide material, and the iron element has a mass content of 3-200 ppm in the zinc sulfide material;
a mass content of zinc in the zinc sulfide material and a pH value of the zinc sulfide material satisfy the following relationship:
$$1. 2 \leq pH - 2.5 \times lg ( {W}_{Zn} ) \leq 3.3 ;$$
where the pH is the pH value of the zinc sulfide material, and W_{Zn} is the mass content of zinc in the zinc sulfide material, expressed in %.

11. The resin composition according to claim 10, wherein the cobalt element has a mass content of 250-400 ppm in the zinc sulfide material.

12. The resin composition according to claim 10, wherein the iron element has a mass content of 6-150 ppm in the zinc sulfide material.

13. The resin composition according to claim 10, wherein the mass content of zinc in the zinc sulfide material and the pH value of the zinc sulfide material satisfy the following relationship: 1.5≤pH−2.5×lg(W_{Zn})≤3.0.

14. The resin composition according to claim 10, wherein the mass content of zinc in the zinc sulfide material is 62.0-67.1%.

15. The resin composition according to claim 10, wherein the pH value of the zinc sulfide material is 5.5-8.0.

16. The resin composition according to claim 10, wherein the zinc sulfide material further comprises a chromium element, and a mass content of the chromium element in the zinc sulfide material is 10-25.2 ppm.

17. The resin composition according to claim 10, wherein the zinc sulfide material has a heating loss of ≤0.5% at 105° C.

18. The resin composition according to claim 10, wherein the resin comprises at least one of polyethylene, polypropylene, polyamide, polycarbonate, poly(butylene terephthalate), poly(ethylene terephthalate), epoxy resin, acrylonitrile-butadiene-styrene copolymer, or styrene-acrylonitrile copolymer.
